(19) United States
(12) Patent Application Publication
(10) Pub. No.: US 2006/0153323 A1
(43) Pub. Date: Jul. 13, 2006

(54) Clock generation device and clock generation method

(75) Inventors: Satoshi Kataoka, Ome-shi (JP); Mitsutaka Kuwabara, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/270,534

(22) Filed: Nov. 10, 2005

(30) Foreign Application Priority Data
Dec. 24, 2004 (JP) 2004-373902

(51) Int. Cl. H04L 7/00; H04J 3/06

(52) U.S. Cl. 375/354; 370/503

(57) ABSTRACT

Upon reception of digital broadcast, system clocks which follow PCR data of an MPEG2-TS are provided. Upon disc playback, system clocks as fixed clocks are provided. To this end, upon processing the MPEG2-TS, first clocks CK1 synchronized with the PCR data are generated. If the user designates playback using high-precision clocks, third clocks CK3 as fixed clocks are generated. If the user does not designate any high-precision clock playback, clocks CK1 are generated. When use of clocks CK1 is stopped, clocks CK3 are generated after second clocks CK2 synchronized with clocks CK3 are mediated.

### CROSS-REFERENCE TO RELATED APPLICATIONS

This application is based upon and claims the benefit of priority from prior Japanese Patent Application No. 2004-373902, filed Dec. 24, 2004, the entire contents of which are incorporated herein by reference.

### BACKGROUND OF THE INVENTION

1. Field of the Invention

The present invention relates to a generation device and generation method of system clocks which are synchronized with a data stream such as an MPEG transport stream or the like.

2. Description of the Related Art

In digital broadcasting, video data, audio data, and the like are compression-encoded by a technique such as that of the Moving Picture Expert Group (MPEG) and the like, and are broadcasted via a satellite communication network or the like. On the receiving side, the encoded bitstream is decoded in real time, and is further converted into analog signals as needed, which are output to a monitor output device. In this way, a viewer can enjoy video and audio data.

A digital broadcast receiver or digital broadcast tuner includes a clock generation device for generating, e.g., 27-MHz clocks, which are synchronized with reference time information such as program clock reference (PCR) data or the like included in the received encoded bitstream (MPEG2-TS) (see FIG. 3 and paragraphs 0003 to 0009 of Japanese Pat. Appln. KOKAI Publication No. 2002-15527). In this reference, one voltage-controlled variable crystal oscillator (VCXO) is used to selectively obtain clocks synchronized with reference time information included in digital data, and clocks of a fixed frequency. With this arrangement, when clocks in phase with the transmitting side are generated and encoded data is decoded at the receiving side, the encoded data can be decoded without causing any overflow or underflow of a buffer that temporarily stores the encoded data. Even in reception for a long period of time, video and audio data can be enjoyed without disturbance.

When an MPEG2-TS (transport stream) input from the digital broadcast tuner is recorded in a recording/playback apparatus, a clock generator forms a phase locked loop (PLL) to obtain clocks synchronized with PCR data included in the MPEG2-TS. Upon playing back a disc or the like that records digital broadcasting, clocks of a fixed frequency (27 MHz) are obtained from the voltage-controlled variable crystal oscillator (VCXO). When clocks of a fixed frequency are generated using the clock generation device with such arrangement, the clocks must be output by changing the control voltage of the VCXO to the fixed frequency. However, since oscillation of the VCXO is influenced by the control voltage, obtained clocks inevitably include jitter.

### BRIEF SUMMARY OF THE INVENTION

A clock generation device according to an embodiment of the invention is configured to selectively obtain clocks CK1 synchronized with reference time information (PCR) included in a data stream upon reception of, e.g., an MPEG2-TS data stream, and fixed-frequency clocks from a variable crystal oscillator (VXO) in other cases. Note that the VXO comprises an oscillator which can solely perform oscillation of a stable, constant frequency, and jitter components can be reduced compared to the voltage-controlled oscillator VCXO.

### BRIEF DESCRIPTION OF THE SEVERAL VIEWS OF THE DRAWING

FIG. 1 is a block diagram showing an example of the arrangement of an information recording/playback apparatus according to an embodiment of the invention;

FIG. 2 is a block diagram showing an example of the arrangement of a clock generation device according to an embodiment of the invention; and

FIG. 3 is a flowchart for explaining the switching sequence of system clocks in a clock generation method according to an embodiment of the invention.

### DETAILED DESCRIPTION OF THE INVENTION

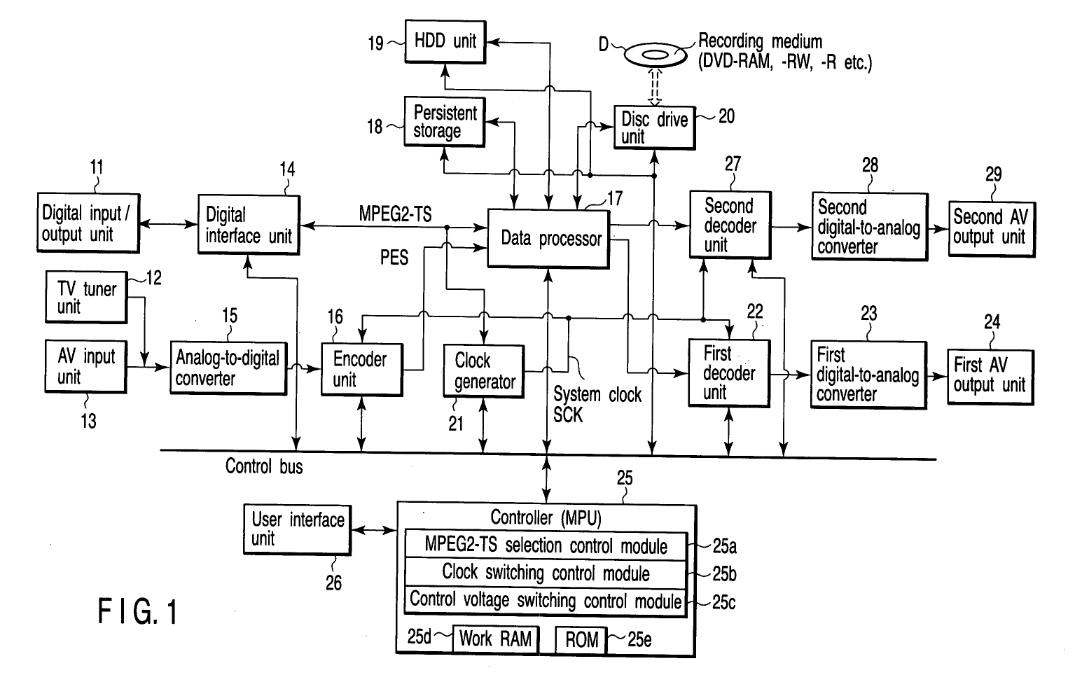

Preferred embodiments of the invention will now be described with reference to the accompanying drawings. FIG. 1 is a schematic diagram showing the arrangement of an information recording/playback apparatus according to an embodiment of the invention. The apparatus shown in FIG. 1 includes digital input/output unit 11, TV tuner unit 12, AV input unit 13, digital interface unit 14, analog-to-digital converter 15, encoder unit 16, data processor 17, persistent storage 18, HDD (hard disc drive) unit 19, disc drive unit 20, recording medium (optical disc of random access RAM type, read/rewrite RW type, or write-once R type using a red or blue laser) D, clock generator 21, first decoder unit 22, first digital-to-analog converter 23, first AV output unit 24, second decoder unit 27, second digital-to-analog converter 28, second AV output unit 29, controller 25, user interface unit 26, and the like. Note that a digital recorder that uses a magnetic tape as a recording medium or a semiconductor recorder that uses a large-capacity flash memory may be connected to data processor 17 to digitally record/play back data.

The arrangement shown in FIG. 1 includes a system (a tuner monitor-out system: components 27 to 29) that outputs video data (video data which does not include any additional picture data/sub-picture data such as OSD data or the like) of a digital tuner, so as to connect, e.g., another recording device (analog VCR or the like). When video/audio data (MPEG2-TS) is supplied from an external digital tuner to data processor 17, video/audio signal decoded by second decoder unit 27 is converted into an analog video/audio signal by second digital-to-analog converter 28. After that, the analog video/audio signal is output to the other recording device via second AV output unit 29. On the other hand, a playback digital video/audio signal from disc drive unit 20 and/or HDD unit 19 is decoded by first decoder unit 22, and is converted into an analog video/audio signal by first digital-to-analog converter 23. The converted analog video/audio signal is output to first AV output unit 24, and is output to an external AV device (digital TV, video switcher, or the like) as a monitor-out signal.

More specifically, components from first decoder unit 22 to first AV output unit 24 can be used in, e.g., a disc playback mode, and components from second decoder unit 27 to second AV output unit 29 can be used as, e.g., a realtime monitor of digital broadcast (this broadcast monitor output can be used as an analog external output for video recording from which additional picture information such as OSD data or the like is deleted).

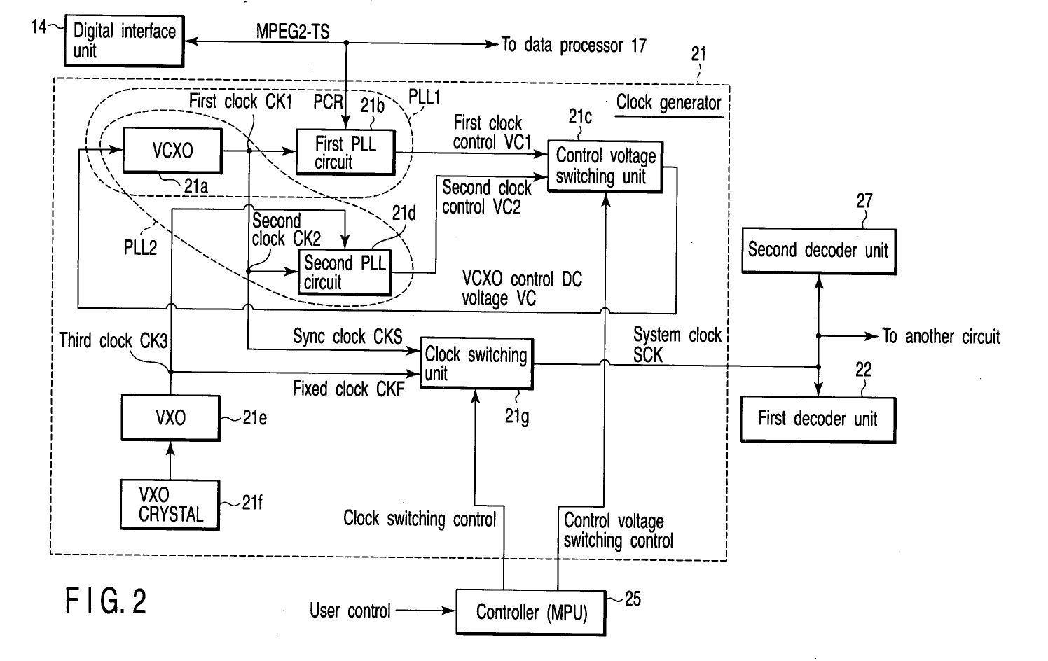

When two decode systems are equipped like in this embodiment, the simultaneous outputs of broadcast reception and disc playback can be made (e.g., follow-up playback of the already recorded digital broadcast data is made while monitoring digital broadcast which is being received). Upon decoding different digital data by such two independent decode systems, if only one clock system (this means only one clock generator 21 including a VCXO and VXO in FIG. 2) is available, clocks (CK1 in FIG. 2 to be described later) synchronized with time information (PCR data of an MPEG2-TS) of the received data stream are used as system clocks.

Controller 25 comprises a microprocessing unit (MPU), which includes as its control software (firmware), MPEG2-TS selection control module 25a, clock switching control module 25b, control voltage switching control module 25c, and the like (MPU 25 includes a ROM area (not shown) for firmware). This controller (MPU) 25 further includes a work RAM 25d used as a work area and the like of control programs, and ROM 25e which stores various parameters required to execute the control programs, on-screen display (OSD) data for an interface, and the like.

MPEG2-TS selection control module 25a of controller 25 receives a user input selection signal by a remote controller operation (not shown) or the like from user interface unit 26, and controls data processor 17 upon selection of a digital signal input and analog signal input. Note that a digital signal to be selected includes an MPEG2-TS signal from digital input/output unit 11 (may also include an MPEG2-PS signal as an object to be selected depending on an embodiment). An analog signal to be selected includes a packetized elementary (PES) stream signal which is obtained by analog-to-digital-converting an analog AV signal from TV tuner unit 12 and/or AV input unit 13 (the PES corresponds to each signal packet to be multiplexed in a program stream [PS] of MPEG2). That is, MPEG2-TS selection control module 25a is configured to output a selection signal used to switch and select the MPEG2-TS and the PES signal of the MPEG2-PS. Data processor 17 is configured to process the TS or PES packets switched and selected by this selection signal.

On the other hand, clock switching control module 25b and control voltage switching control module 25c of controller 25 control clock generator 21 depending on whether or not the selected input signal is a digital signal (MPEG2-TS or the like). Details of this control will be described later with reference to FIG. 2. In this embodiment, user interface unit 26 forms means for allowing the user to input various instructions to controller 25 via a remote controller (not shown) or a control panel (not shown) of the apparatus shown in FIG. 1.

As components that execute read/write (video recording and/or playback) processing of information with respect to recording medium D, disc drive unit 20 having an optical system and drive system, data processor 17, persistent storage 18, and clock generator (system time counter or system time clock: STC) 21 are equipped. Persistent storage 18 is used to buffer a predetermined size of data (data output from encoder unit 16) to be written in recording medium D via disc drive unit 20 and data processor 17, and to buffer a predetermined size of data (data input to decoder unit 22) played back from recording medium D via disc drive unit 20 and data processor 17. Disc drive unit 20 has a rotation control system, laser drive system, optical system, and the like for an optical disc.

Analog video and audio signals output from TV tuner unit 12 and/or AV input unit 13 are converted into a digital video/audio signal by analog-to-digital converter 15. The video/audio signal is encoded by encoder unit 16. More specifically, the video signal is compressed using, e.g., the MPEG2 compression encoding method, and the audio signal is encoded by linear pulse code modulation (LPCM) or using an audio digital compression method (MP2, AAC, AC-3, or the like) in accordance with a mode selected in advance, thus generating a compressed stream (MPEG2-PS signal) by multiplexing these signals. The encoded data (MPEG2-PS) or digitally input data stream (MPEG2-TS or the like) goes through data processor 17, and is recorded on recording medium D via disc drive unit 20 and/or HDD unit 19.

On the other hand, in a playback mode, playback data (MPEG2-TS or MPEG2-PS) is supplied from recording medium D via disc drive unit 20 or from HDD unit 19 to data processor 17, and a video/audio signal decoded by decoder unit 22 is output. Furthermore, the digital video/audio signal is converted into an analog video/audio signal by digital-to-analog converter 23. Finally, the analog video/audio signal is output to AV output unit 24, and can be viewed on a normal TV receiver. These operations are controlled by controller 25 via a control bus in accordance with an instruction from user interface unit 26.

In the information recording/playback apparatus shown in FIG. 1, digital interface unit 14 is connected between digital input/output unit 11 and data processor 17 via a two-way bus. By connecting an external apparatus (not shown) to digital input/output unit 11 via a digital link, encoded video/audio data (data stream such as an MPEG2-TS or the like) from the external apparatus can be recorded on recording medium D, encoded video/audio data (data stream such as an MPEG2-TS or the like) played back from recording medium D can be output to the external apparatus.

As the external apparatus, apparatuses such as a digital broadcast receiver, digital broadcast tuner (set-top box [STB]), and the like may be connected. As an interface of the digital link between this external apparatus and the information recording/playback apparatus shown in FIG. 1, an interface complying with the Institute of Electrical and Electronics Engineers (IEEE) 1394 standard or the like may be used.

The encoded video/audio data input from the external apparatus to digital input/output unit 11 undergoes processing such as format conversion and the like in digital interface unit 14 as needed, and is converted into a format (MPEG2-TS or MPEG2-PS) suited to the information recording/playback apparatus. The converted video/audio data goes through data processor 17, and is recorded on recording medium D via disc drive unit 20 and/or on HDD unit 19. At the same time, data processor 17 demultiplexes MPEG2-TS and PES data to be recorded, and the demultiplexed PES data is supplied to MPEG video/audio decoder unit 22, thus outputting analog video and audio signals corresponding to the video/audio data from the external apparatus to AV output unit 24.

When first decoder unit 22 (and/or second decoder unit 27) has an MPEG2-TS decode function (in addition to the MPEG-PS decode function), data processor 17 can supply MPEG-TS data to decoder unit 22 (27). In this case, the playback video picture of the MPEG2-TS contents recorded (or being recorded) on HDD unit 19 and/or recording medium D can be output to first AV output unit 24 (and/or second AV output unit 29) without using any internal decoder of, e.g., an STB or the like externally connected via IEEE 1394 or the like.

FIG. 2 is a block diagram showing an example of the arrangement of the clock generation device according to the embodiment of the invention. A case will be explained below wherein a digital broadcast tuner (STB [not shown]) is connected as an external apparatus to the information recording/playback apparatus with the arrangement shown in FIG. 1, an encoded bitstream (MPEG2-TS or the like) received by the digital broadcast tuner is input to the information recording/playback apparatus and is recorded on HDD unit 19 (and/or optical disc D loaded in disc drive unit 20), and the encoded bitstream played back from HDD unit 19 (and/or optical disc D) is decoded and output to AV output unit 24.

FIG. 2 shows an example of clock generator 21 of the information recording/playback apparatus in such case. Clock generator 21 of this example comprises voltage-controlled variable crystal oscillator (VCXO) 21a, first PLL circuit 21b, control voltage switching unit 21c, second PLL circuit 21d, variable crystal oscillator (VXO) 21e, and crystal 21f for VXO.

Clock generator 21 comprises VCXO 21a whose oscillation frequency changes within a predetermined range having 27 MHz as the center in accordance with a control voltage, first PLL circuit 21b which forms first phase locked loop PLL1 together with this VCXO 21a, and second PLL circuit 21d which forms second phase locked loop PLL2 together with this VCXO 21a.

When PLL1 is active, first clock control voltage VC1 from first PLL circuit 21b is selected by control voltage switching unit 21c so that clocks CK1 from VCXO 21a are phase-locked (synchronized) with PCR data (or system clock reference [SCR] included in an MPEG2-PS) as reference time information included in an MPEG2-TS output from digital interface unit 14 onto the two-way bus (since PCR data is often slightly different depending on broadcast stations, clocks independently synchronized with PCR data for respective stations are required to support data streams from various broadcast stations).

When PLL2 is active, second clock control voltage VC2 from second PLL circuit 21d is selected by control voltage switching unit 21c so that clocks CK2 from VCXO 21a are phase-locked (synchronized) with fixed clocks CK3 from VXO 21e.

That is, when control voltage switching unit 21c is switched to activate PLL1, sync clocks CKS (=CK1) phase-locked (synchronized) with reference time information (PCR or the like) included in the digital input (data stream such as an MPEG2-TS or the like) are obtained from VCXO 21a. On the other hand, when control voltage switching unit 21c is switched to activate PLL2, sync clocks CKS phase-locked (synchronized) with fixed clocks CK3 from VXO 21e are obtained from VCXO 21a. Note that VXO 21e stably oscillates (e.g., an oscillation frequency of 27 MHz) independent from the digital input (data stream such as an MPEG2-TS or the like).

When system clocks SCK synchronized with the digital input (data stream such as an MPEG2-TS or the like) are required, sync clocks CKS=CK1 are selected by the operation of PLL1. After the sync clocks are temporarily phase-locked with VXO 21e by the operation of PLL2 upon executing, e.g., disc playback, fixed clocks CKF=CK3 are then selected as system clocks SCK. In this manner, since clocks CK2 synchronized with CK3 are mediated in the process of switching sync clocks CKS=CK1 to fixed clocks CKF=CK3, clock discontinuity upon clock switching can be avoided.

In the embodiment of the invention, sync clocks CKS are phase-locked with PCR data of an MPEG2-TS. However, sync clocks CKS may be phase-locked with another time reference value (e.g., SCR of an MPEG1-PS or MPEG2-PS) depending on embodiments.

Control voltage switching unit 21c is configured to select first PLL circuit 21b (PLL1) and second PLL circuit 21d (PLL2) on the basis of a control voltage switching signal from controller 25. Clock switching unit 21g is configured to select sync clocks CKS (=first clocks CK1 or second clocks CK2) and fixed clocks CKF (=third clocks CK3) on the basis of a clock switching signal from controller 25.

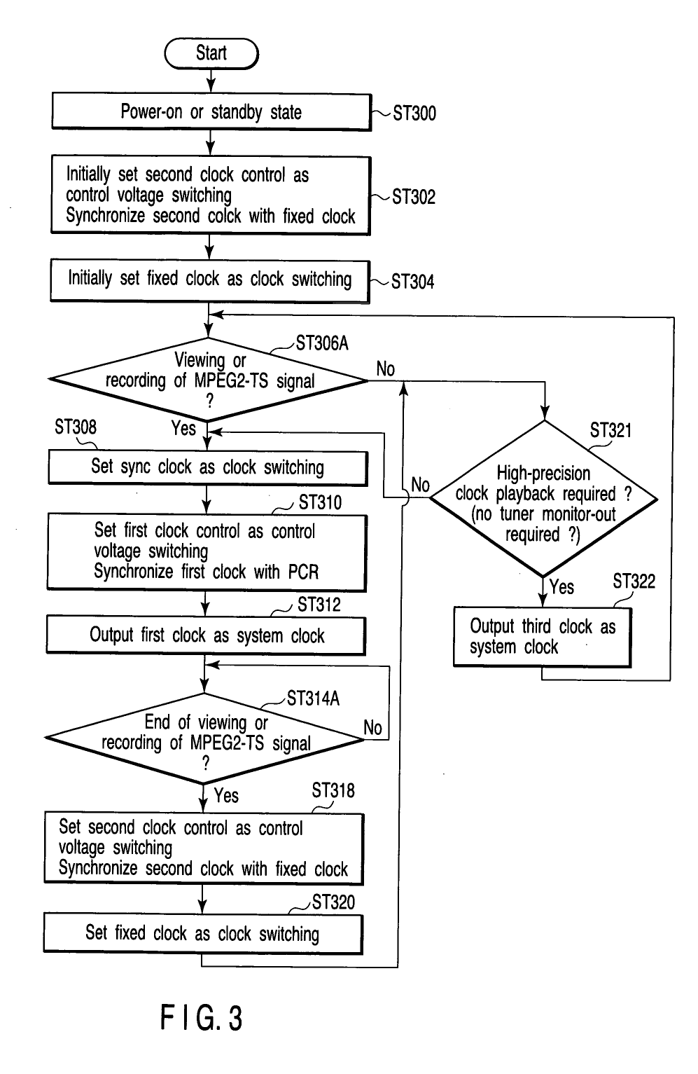

In the arrangement shown in FIG. 2, upon reception of an instruction indicating that the user wants to use high-precision clocks (use fixed clocks CK3: corresponding to YES in step ST321 in FIG. 3) or that the user requires a monitor-out signal of digital broadcast (use sync clocks CK1: corresponding to NO in step ST321 in FIG. 3) via user interface unit 26 of FIG. 1 (via a remote controller operation (not shown)), controller 25 is configured to follow that instruction. Also, when the instruction indicating that the user wants to use high-precision clocks (use fixed clocks CK3) and the instruction indicating that the user requires a monitor-out signal of digital broadcast (use sync clocks CK1) are received at the same time, or when none of these instructions are input, controller 25 is configured to select sync clocks CK1 (give priority to NO in step S321 in FIG. 3).

FIG. 3 is a flowchart for explaining the system clock switching sequence in a clock generation method according to an embodiment of the invention. The processing of this flowchart can be executed by MPU 25 in FIG. 1, and the processing sequence can be written as, e.g., firmware of clock switching control module 25b and the like.

When the power supply of the information recording/playback apparatus is turned on (or when a main switch of the power supply is turned on and the control then enters a power-on standby state), processing starts (step ST300). Controller 25 sets control voltage switching unit 21c on the second clock control side to activate the second PLL circuit 21d system (PLL2 system) so as to generate sync clocks synchronized with fixed clocks as an initial setting (as a preparation for switching between fixed blocks and sync clocks) (step ST302). As a result, second clocks CK2 synchronized with fixed clocks CKF are generated. Also, controller 25 sets clock switching unit 21g on the fixed clock side to use third clocks CK3 of fixed-frequency VXO 21e as system clocks SCK (step ST304).

Next, controller 25 checks upon, e.g., selection of the digital broadcast tuner connected to digital input/output unit 11 if an MPEG2-TS signal is to be newly viewed or recorded (step ST306A). (If no MPEG2-TS signal is available, since it cannot be viewed or recorded, determination in step S306A substantially includes that of the presence/absence of reception of an MPEG2-TS signal.) If YES in step S306A, i.e., if an MPEG2-TS signal is to be newly viewed or recorded, controller 25 outputs a clock switching signal to clock switching unit 21g to switch from the fixed clock side to the sync clock side, thus outputting second clocks CK2 of sync clocks input from VCXO 21a as system clocks SCK (step ST308).

Controller 25 then outputs a control voltage switching signal to control voltage switching unit 21b to activate the first PLL circuit 21b system (PLL1 system) to select the first clock control side, and generates first clocks synchronized with PCR data as reference time information included in the MPEG2-TS signal (step ST310). As a result, sync clocks CKS are changed from second clocks CK2 to first clocks CK1, and first clocks CK1 are output as system clocks SCK (=CK1) (step ST312).

Controller 25 checks if viewing or recording of the MPEG2-TS signal ends (step ST314A). (Determination in step ST314A may include that which pertains to the presence/absence of reception of an MPEG2-TS signal. That is, even when the MPEG2-TS signal is received, its viewing or recording can be ended by a user operation or the like, and when the MPEG2-TS signal ceases to be received, its viewing or recording can be immediately ended.) If NO in step ST314A, i.e., if viewing or recording of the MPEG2-TS signal is continued, the first clocks are continuously output as the system clocks (SCK=CK1).

If YES in step ST314A, i.e., if viewing or recording of the MPEG2-TS signal ends (or if the MPEG2-TS signal ceases to be received due to, e.g., power off of the external digital tuner), controller 25 outputs a control voltage switching signal to control voltage switching unit 21b to activate the second PLL circuit 21d system, thus selecting the second clock side. As a result, sync clocks CKS from VCXO 21a change from first clocks CK1 synchronized with the PCR data of the MPEG2-TS signal to second clocks synchronized with fixed clocks CKF (=third clocks CK3) of VXO 21e (step ST318). Controller 25 then outputs a clock switching signal to clock switching unit 21g to select the fixed clock side (step ST320). In this case, for example, if disc playback is to be made using high-precision, fixed clocks CK3 or no monitor-out signal of the digital tuner is required (in other words, first clocks CK1 synchronized with the PCR data of the MPEG2-TS need not be used) according to the user's desire (will) (YES in step ST321), third clocks CK3 are output as system clocks SCK (step ST322).

On the other hand, if NO in step ST306A, i.e., if no MPEG2-TS signal is to be viewed or recorded, controller 25 selects in accordance with the designation from the user or the like if sync clocks (first clocks CK1) or fixed clocks (third clocks CK3) are used (step ST321). That is, upon reception of an instruction indicating that the user wants to use high-precision clocks (use fixed clocks CK3: YES in step ST321) or that the user requires a monitor-out signal of digital broadcast (use sync clocks CK1: NO in step ST321) from the user (or a control program of program viewing or the like created according to the user's desire) via user interface unit 26, controller 25 is configured to follow that instruction.

After that, it is checked if the MPEG2-TS signal is to be viewed or recorded (step ST306A). If NO in step S306A, i.e., if no MPEG2-TS signal is to be viewed or recorded (or no MPEG2-TS signal is received), or after viewing or recording of the MPEG2-TS signal ends (from YES in step ST314A to step ST320), third clocks are continuously output as system clocks (SCK=CK3) unless sync clocks CK1 are required (unless NO in step ST321) according to the user control.

If the user instruction indicating use of high-precision clocks (use of fixed clocks CK3) and the user instruction indicating requirement of a monitor-out signal of digital broadcast (use of sync clocks CK1) are simultaneously received or if no user instruction indicating use of CK1 or CK3 is input in the processing of step ST321, controller 25 is configured to preferentially select sync clocks CK1 (preferentially set NO in step ST321 in FIG. 3 as a default).

If sync clocks CK1 are preferentially selected in the processing of step ST321 (or NO is selected as a default in step ST321), since sync clocks CK1 synchronized with reference time information (PCR data of an MPEG2-TS or the like) of digital broadcast are adopted, the tuner monitor-out and disc playback functions can be simultaneously implemented by one clock generation device system (although jitter of system clocks used upon disc playback may slightly impair compared to use of fixed clocks CK3).

More specifically, broadcast video recording by connecting a video recorder (DVD-VR recorder, analog VCR, or the like) to the tuner monitor-out (for example, the output from second AV output unit 29 in FIG. 1), recorded disc playback (for example, the output from first AV output unit 24 in FIG. 1) can be implemented by one clock generation device system (e.g., clock generator 21 in FIG. 2 and the like). On the other hand, if no tuner monitor-out is required, advanced disc playback using fixed clocks CK3 can be implemented by one clock generation device system.

More specifically, execution of processing corresponding to viewing or recording of digital broadcast using sync clocks CK1, and use of fixed clocks CK3 which can assure low jitter and high precision upon disc playback or the like can be implemented by one clock generation device system depending on user's desire or the like (YES/NO in step ST321). This is one of important points of an embodiment of the invention.

Furthermore, in an embodiment of the invention, upon switching clocks CKS=CK1 synchronized with PCR data which may change for respective broadcast stations to fixed clocks CKF=CK3 which are stable independently of PCR data, CK2 (=phase-locked with CK3) are mediated in place of directly switching from CK1 to CK3. (CK1 and CK3 may have an asynchronous relationship, but since clocks CK1 continuously change to clocks CK2 by the PLL operation, no clock discontinuity occurs. Also, since clocks CK2 and CK3 have a synchronous relationship, no clock discontinuity occurs upon switching from CK2 to CK3.) This is also one of important points of an embodiment of the invention.

### Effects According to Embodiment

As described above, according to an embodiment of the invention, upon reception of digital broadcast, system clocks that follow reference time information of the received data stream are precisely generated. Furthermore, upon disc playback, system clocks which can assure low jitter, high purity, and minimal frequency variations are provided (according to the grade of crystal 21f used). In this way, environments suited to respective playback processes are realized, and optimal video processing operations can be performed.

Furthermore, even when the user does not view or record digital broadcast using the apparatus shown in FIGS. 1 and 2 (NO in step ST306A), if he or she issues an instruction corresponding to NO in step ST321 in FIG. 3, a decode output of digital broadcast can be supplied (from second AV output unit 29 in FIG. 1) to another AV apparatus. More specifically, when the user wants to play back a DVD disc or the like with high image quality, or when the user wants to use a monitor-out signal of the digital tuner, clock switching can be controlled in accordance with the user's desire.

Upon switching between fixed clocks (VXO) and sync clocks (VCXO), clocks may cause temporary discontinuity unless they are switched after their phases are locked. For this reason, upon switching from sync clocks (VCXO) to fixed clocks (VXO), the clock generator may form a PLL which is phase-locked with the VXO to temporarily synchronize sync clocks (VCXO) with fixed clocks (VXO), and may then switch the VCXO synchronized with the VXO to fixed clocks (VXO).

When fixed clocks (VXO) are selected, no monitor output of the digital tuner is available at all. Hence, when a monitor-out of the digital tuner is required, clock selection processing (step ST321) may be opened to the user or the like and output of sync clocks (VCXO) may be selected according to the user's desire.

Also, the clock switching unit that switches between the fixed clocks and sync clocks can be configured to output the fixed clocks as system clocks in a power-on standby state and power-on state.

When no data stream is detected, the clock switching unit may be configured to output the fixed clocks as the system clocks.

Furthermore, the clock generation method according to an embodiment of the invention can be configured to generate sync clocks synchronized with reference time information from a data stream, and to output one of the sync clocks and predetermined fixed clocks as system clocks.

Upon reception of digital broadcast or the like, system clocks that follow reference time information of the received data stream (e.g., sync clocks phase-locked with PCR data) are precisely generated. Furthermore, upon disc playback or the like, system clocks which can assure low jitter, high purity, and minimal frequency variations (e.g., fixed clocks obtained from the crystal having an independent arrangement free from any external influences) are provided. In this way, environments suited to respective playback processes are realized, and optimal video processing operations can be performed.

Moreover, even in the simultaneous outputs of broadcast reception and disc playback (e.g., follow-up playback of the already recorded digital broadcast data is made while monitoring a digital broadcast which is being received), optimal video processing operations can be performed.

Note that the invention is not limited to the above description, and can be used in recording/playback of general DVD, analog broadcasts, and the like. Even in such case, high-precision playback can be made while switching to fixed clocks.

Note that the invention is not limited to the aforementioned embodiment, and various modifications may be made on the basis of techniques available at that time without departing from the scope of the invention when it is practiced at present or in the future. For example, in the description of the above embodiment, a data stream which passes through digital input/output unit 11 of FIG. 1 is an MPEG2-TS. However, the invention is not limited to the MPEG2-TS. This data stream may be a bitstream of MPEG4 (H264) or a bitstream from a DVD streamer (DVD-SR).

The respective embodiments may be combined as needed as much as possible, and combined effects can be obtained in such case. Furthermore, the embodiments include inventions of various stages, and various inventions can be extracted by appropriately combining a plurality of required constituent elements disclosed in this application. For example, even when some required constituent elements are omitted from all the required constituent elements disclosed in the embodiments, an arrangement from which those required constituent elements are omitted can be extracted as an invention.

What is claimed is:

1. An electronic device comprising:
a first PLL circuit configured to generate a sync clock synchronized with reference time information from a data stream;
an oscillator configured to generate a fixed clock;
a designation unit configured to designate whether the sync clock or the fixed clock is adopted;
a controller configured to output a clock switching signal in correspondence with the designation by the designation unit; and
a clock switching unit configured to switch and select one of the sync clock and the fixed clock in accordance with the clock switching signal from the controller, and to output the selected clock as a system clock.

2. The device of claim 1, wherein the first PLL circuit generates a first sync clock synchronized with the reference time information from the data stream, and
the electronic device further comprises:
a second PLL circuit configured to generate a second sync clock synchronized with the fixed clock;
a designation unit configured to designate whether the sync clock or the fixed clock is adopted;
a controller configured to output a control voltage switching signal and a clock switching signal in correspondence with the designation by the designation unit;
a control voltage switching unit configured to switch the first sync clock generated by the first PLL circuit and the second sync clock generated by the second PLL circuit in accordance with the control voltage switching signal from the controller, and to control one of the first PLL circuit and the second PLL circuit to output the switched clock as the sync clock; and
a clock switching unit configured to switch and select one of the sync clock and the fixed clock in accordance with the clock switching signal from the controller, and to output the selected clock as a system clock.

3. The device of claim 2, wherein the clock switching unit is configured to switch the sync clock to the fixed clock when the second sync clock is output as the sync clock.

4. The device of claim 1, wherein the clock switching unit is configured to preferentially select the sync clock when the designation unit simultaneously designates the sync clock and the fixed clock or when the designation unit makes no designation.

5. An information recording/playback apparatus which comprises a drive device configured to record or play back using an information storage medium, and a clock generation device configured to generate a system clock, records a data stream on the information storage medium in a predetermined format using the system clock, or plays back the recorded information, the clock generation device comprising:
a first PLL circuit configured to generate a first sync clock synchronized with reference time information from the data stream;
an oscillator configured to generate a fixed clock;
a second PLL circuit configured to generate a second sync clock synchronized with the fixed clock;
a designation unit configured to designate whether the sync clock or the fixed clock is adopted;
a controller configured to output a control voltage switching signal and a clock switching signal in correspondence with the designation by the designation unit;
a control voltage switching unit configured to switch the first sync clock generated by the first PLL circuit and the second sync clock generated by the second PLL circuit in accordance with the control voltage switching signal from the controller, and to control one of the first PLL circuit and the second PLL circuit to output the switched clock as the sync clock; and
a clock switching unit configured to switch and select one of the sync clock and the fixed clock in accordance with the clock switching signal from the controller, and to output the selected clock as the system clock.

6. The apparatus of claim 4, wherein the control unit is configured to output a selection signal used to switch and select a transport stream and packetized elementary stream of MPEG, and
the information recording/playback apparatus further comprises a data processor configured to process packets of the transport stream or the packetized elementary stream switched and selected by the selection signal.

7. The apparatus of claim 6, wherein when the transport stream is selected by the selection signal from the controller, the control voltage switching unit is set to generate the first sync clock, and the clock switching unit is set to output the first sync clock as the system clock.

8. The apparatus of claim 6, wherein when the packetized elementary stream is selected by the selection signal from the controller, the control voltage switching unit is set to generate the second sync clock, and the clock switching unit is then set to output the fixed clock as the system clock.

9. The apparatus of claim 5, wherein the clock switching unit is configured to preferentially select the sync clock when the designation unit simultaneously designates the sync clock and the fixed clock or when the designation unit makes no designation.

10. A clock generation method comprising:
generating, when a data stream including reference time information is to be processed, a first sync clock synchronized with the reference time information;
generating, when a predetermined fixed clock of the first sync clock and the predetermined fixed clock is designated to be adopted, the fixed clock;
generating, when the first sync clock of the first sync clock and the fixed clock is designated to be adopted, the first sync clock; and
generating, when the first sync clock is not to be used, mediating a second sync clock synchronized with the fixed clock, and then generating the fixed clock.

11. The method of claim 10, further comprising: preferentially selecting, when the first sync clock and the fixed clock are simultaneously designated, or when no designation is made, the first sync clock.

12. The apparatus of claim 6, wherein the clock switching unit is configured to output the fixed clock as the system clock when a power supply of the information recording/playback apparatus is turned on or in a standby state before the power supply is turned on.

13. The apparatus of claim 6, wherein the clock switching unit is configured to output the fixed clock as the system clock when no transport stream is detected.
